(19) United States
(12) Patent Application Publication
(10) Pub. No.: US 2020/0233503 A1
(43) Pub. Date: Jul. 23, 2020

(54) VIRTUALIZATION OF TANGIBLE OBJECT COMPONENTS

(71) Applicant: Tangible Play, Inc., Palo Alto, CA (US)

(72) Inventors: Ariel Zekelman, Palo Alto, CA (US); Arnaud Brejeon, Yorba Linda, CA (US); Jerome Scholler, San Francisco, CA (US); Heidy Cristina Maldonado Lopez, Mountain View, CA (US)

(21) Appl. No.: 16/750,500

(22) Filed: Jan. 23, 2020

Related U.S. Application Data
(60) Provisional application No. 62/795,696, filed on Jan. 23, 2019.
(60) Provisional application No. 62/838,815, filed on Apr. 25, 2019.

(51) Int. Cl. G06F 3/0354; G06F 3/01; G06F 3/03; G06T 13/80; G09B 5/02; G09B 1/30; G09B 19/00

(52) U.S. Cl. CPC G06F 3/0354; G06F 3/011; G06F 3/0304; G09B 19/00; G09B 5/02; G09B 1/30; G06T 13/80

(57) ABSTRACT

Various implementations for virtualization of tangible object components include a method that includes capturing a video stream a video stream of a physical activity scene, the video stream including a first tangible interface object and a second tangible interface object positioned on the physical activity scene, identifying a combined position of the first tangible interface object relative to the second tangible interface object, determining a virtual object represented by the combined position of the first tangible interface object relative to the second tangible interface object, and displaying a graphical user interface embodying a virtual scene, the virtual scene including the virtual object.

### BACKGROUND

The present disclosure relates to detection and visualization of a formation of an object out of one or more component tangible interface objects, and in a more specific non-limiting example, detection and identification of the tangible interface objects.

A tangible object visualization system allows a user to use the visualization system to capture tangible objects and see the objects presented as visualizations on an interface within the system. Providing software-driven visualizations associated with the tangible objects allows for the user to interact and play with tangible objects while also realizing the creative benefits of the software visualization system. This can create an immersive experience where the user has both tangible and digital experiences that interact with each other.

In some solutions, objects may be placed near the visualization system and a camera may capture images of the objects for image processing. However, the images captured by the camera for image processing, require the object to be placed in a way that the image processing techniques can recognize the object. Often, when a user is playing with the object, such as when using the visualization system, the object will be obscured by the user or a portion of the user's hand and the movement and placement of the visualization system may result in poor lighting and image capture conditions. As such, significant time and processing must be spent to identify the object and if the image cannot be analyzed because of poor quality or the object being obscured, then a new image must be captured, potentially resulting in losing a portion of an interaction with the object by the user.

Some visualization systems attempt to address this problem by limiting the ways in which a user can interact with an object in order to capture images that are acceptable for image processing. For example, the visualization system may require that only specific objects that are optimized for image processing be used and may even further constrain the user by only allowing the objects to be used in a specific way. However, limiting the interactions, such as by requiring a user to place an object and not touch it, often create a jarring experience in which the user is not able to be immersed in the experience because of the constraints needed to capture the interactions with the object. Limiting the objects to only predefined objects also limits the creativity of the user.

Further issues arise in that specific setup of specialized objects in a specific configuration is often required in order to interact with the objects and the system. For example, an activity surface must be carefully setup to comply with the calibrations of the camera and if the surface is disturbed, such as when it is bumped or moved by a user, the image processing loses referenced calibration points and will not work outside of the constraints of the specific setup. These difficulties in setting up and using the visualization systems, along with the high costs of these specialized system has led to limited adoption of the visualization systems because of the user is not immersed in their interactions with the objects.

Furthermore, studies have shown that children are still learning concepts such as their ABCs the same way as they were more than a hundred years ago. Current visualization systems discussed above have not been able to overcome the described challenges to change the process in which educational concepts are presented to children.

### SUMMARY

According to one innovative aspect of the subject matter in this disclosure, a method for virtualization of tangible object components is described. In an example implementation, a method includes capturing, using a video capture device associated with a computing device, a video stream of a physical activity scene, the video stream including a first tangible interface object and a second tangible interface object positioned on the physical activity scene; identifying, using a processor of the computing device, a combined position of the first tangible interface object relative to the second tangible interface object; determining, using the processor of the computing device, a virtual object represented by the combined position of the first tangible interface object relative to the second tangible interface object; and displaying, on a display of the computing device, a graphical user interface embodying a virtual scene, the virtual scene including the virtual object.

Other implementations may include one or more of the following features. The method includes where the first tangible interface object is a stick and the second tangible interface object is a ring. The method may include: identifying, using the processor of the computing device, a first position and a first orientation of the stick; identifying, using the processor of the computing device, a second position and a second orientation of the ring; and where identifying the combined position includes matching the first position and the first orientation of the stick and the second position and the second orientation of the ring to a database of virtualizations that includes the virtual object and the virtual object is formed out of one or more of a virtual stick and a virtual ring. The method of claim may include where the virtual object represents one of a number, a letter, a shape, and an object. The method may include where the virtual scene includes an animated character, the method may include: displaying the animated character in the graphical user interface; determining an animation routine based on the combined position of the first tangible interface object relative to the second tangible interface object; and executing, in the graphical user interface, the animation routine. The method may include where the video stream includes a third tangible interface object positioned in the physical activity scene, the method may include: updating the combined position based on a location of the third tangible interface object relative to the first tangible interface object and the second tangible interface object; identifying a new virtual object based on the updated combined position; and displaying, on the display of the computing device, the virtual scene including the new virtual object. The method may include: displaying, on the display of the computing device, a virtual prompt, the virtual prompt representing an object for a user to create on the physical activity scene; detecting in the video stream, a placement of the first tangible interface object and the second tangible interface object on the physical activity scene; determining that the combined position of the first tangible interface object relative to the second tangible interface object matches an expected virtual object based on the virtual prompt; and displaying, on the display of the computing device, a correct animation. The method may include where the virtual prompt includes highlighting to signal a shape of the first tangible interface object. The method may include: determining, using the processor of the computing device, that the first tangible interface object is placed incorrectly to match the expected virtual object; and determining, using the processor of the computing device, a correct placement of the first tangible interface object. The method may include where the highlighting is presented on the display responsive to determining that the first tangible interface object is placed incorrectly and the highlighting signals the correct placement of the first tangible interface object.

One general aspect includes a physical activity visualization system may include: a video capture device coupled for communication with a computing device, the video capture device being adapted to capture a video stream that includes a first tangible interface object and a second tangible interface object positioned on a physical activity scene; a detector coupled to the computing device, the detector being adapted to identify within the video stream a combined position of the first tangible interface object relative to the second tangible interface object; a processor of the computing device, the processor being adapted to determine a virtual object represented by the combined position of the first tangible interface object relative to the second tangible interface object; and a display coupled to the computing device, the display being adapted to display a graphical user interface embodying a virtual scene, the virtual scene including the virtual object.

Implementations may include one or more of the following features. The physical activity scene visualization system, where the first tangible interface object is a stick and the second tangible interface object is a ring. The physical activity scene visualization system, where the process of the computing device is further configured to: identify a first position and a first orientation of the stick; identify a second position and a second orientation of the ring; and where identifying the combined position includes matching the first position and the first orientation of the stick and the second position and the second orientation of the ring to a database of virtualizations that includes the virtual object and the virtual object is formed out of one or more of a virtual stick and a virtual ring. The physical activity scene visualization system where the virtual object represents one of a number, a letter, a shape, and an object. The physical activity scene visualization system where the virtual scene includes an animated character, and where the display is adapted to display the animated character in the graphical user interface, and where the processor is adapted to: determine an animation routine based on the combined position of the first tangible interface object relative to the second tangible interface object; and execute in the graphical user interface, the animation routine. The physical activity scene visualization system where the video stream includes a third tangible interface object positioned in the physical activity scene, and where the processor is further adapted to: update the combined position based on a location of the third tangible interface object relative to the first tangible interface object and the second tangible interface object; identify a new virtual object based on the updated combined position; and where the display is further adapted to display the virtual scene including the new virtual object. The physical activity scene visualization system where the display is further adapted to display a virtual prompt, the virtual prompt representing an object for a user to create on the physical activity scene and where the processor is further adapted to: detect in the video stream, a placement of the first tangible interface object and the second tangible interface object on the physical activity scene; determine that the combined position of the first tangible interface object relative to the second tangible interface object matches an expected virtual object based on the virtual prompt; and where the display is further adapted to display a correct animation. The physical activity scene visualization system where the virtual prompt includes highlighting to signal a shape of the first tangible interface object. The physical activity scene visualization system where the processor is further adapted to: determine that the first tangible interface object is placed incorrectly to match the expected virtual object; and determine a correct placement of the first tangible interface object. The physical activity scene visualization system where the display is further adapted to present the highlighting on the display responsive to the processor determining that the first tangible interface object is placed incorrectly and the highlighting signals the correct placement of the first tangible interface object.

One general aspect includes a method may include: capturing, using a video capture device associated with a computing device, a video stream of a physical activity scene, the video stream including a first tangible interface object representing a stick and a second tangible interface object representing a half-ring, the first tangible interface object being positioned adjacent to an end of the second tangible interface object on the physical activity scene to create a shape; identifying, using a processor of the computing device, a first position of the first tangible interface object; identifying, using the processor of the computing device, a second position of the second tangible interface object; identifying, using the processor of the computing device, the shape depicted by the first position of the first tangible interface object relative to the second position of the second tangible interface object; determining, using the processor of the computing device, a virtual object represented by the identified shape, by matching the shape to a database of virtual objects and identifying a matching candidate that exceeds a matching score threshold; and displaying, on a display of the computing device, a graphical user interface embodying a virtual scene, the virtual scene including the virtual object.

Other implementations of one or more of these aspects and other aspects described in this document include corresponding systems, apparatus, and computer programs, configured to perform the actions of the methods, encoded on computer storage devices. The above and other implementations are advantageous in a number of respects as articulated through this document. Moreover, it should be understood that the language used in the present disclosure has been principally selected for readability and instructional purposes, and not to limit the scope of the subject matter disclosed herein.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 is an example configuration of a virtualization of tangible object components.

FIG. 2 is a block diagram illustrating an example computer system for virtualization of tangible object components.

FIG. 3 is a block diagram illustrating an example computing device.

FIGS. 4A-4D are example configurations of a virtualization of tangible object components.

FIGS. 5A-5E are example configurations of a virtualization of tangible object components.

FIGS. 6A-6D are example configurations of a virtualization of tangible object components.

FIG. 7 is an example configuration of a virtualization of tangible object components.

FIG. 8 is a flowchart of an example method for virtualization of tangible object components.

### DETAILED DESCRIPTION

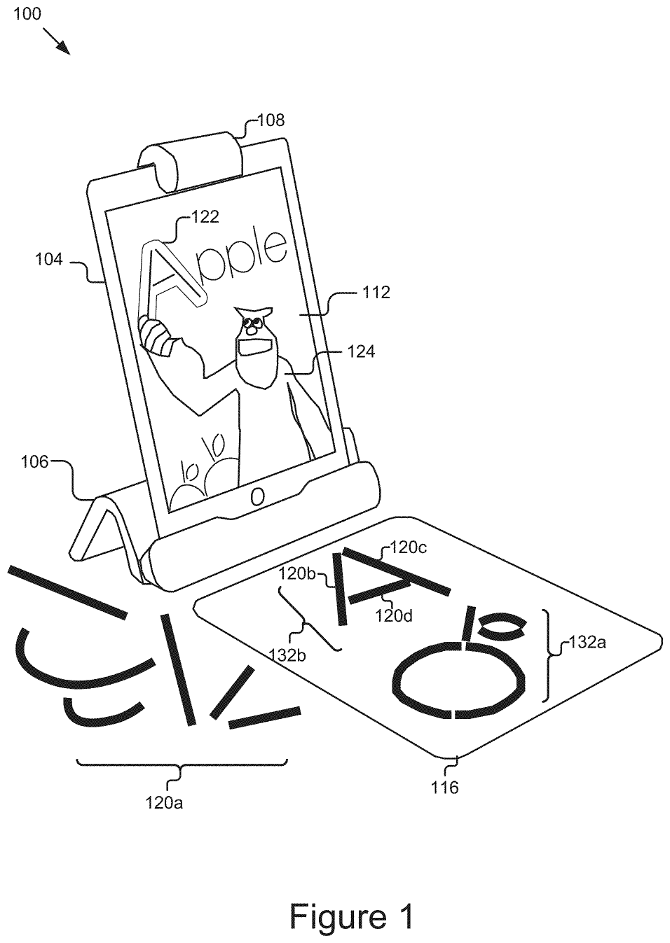

FIG. 1 is an example configuration 100 of a virtualization of tangible object components 120 on a physical activity surface 116. As depicted, the configuration 100 includes, in part, a tangible, physical activity surface 116, on which tangible interface objects 120 may be positioned (e.g., placed, drawn, created, molded, built, projected, etc.) and a computing device 104 that is equipped or otherwise coupled to a video capture device 110 (not shown) coupled to an adapter 108 configured to capture video of the physical activity surface 116. The computing device 104 includes novel software and/or hardware capable of displaying a virtual scene 112 including in some implementations a virtual character 124 and/or a virtual object 122 along with other virtual elements.

While the physical activity surface 116 on which the platform is situated is depicted as substantially horizontal in FIG. 1, it should be understood that the physical activity surface 116 can be vertical or positioned at any other angle suitable to the user for interaction. The physical activity surface 116 can have any color, pattern, texture, and topography. For instance, the physical activity surface 116 can be substantially flat or be disjointed/discontinuous in nature. Non-limiting examples of an activity surface include a table, desk, counter, ground, a wall, a whiteboard, a chalkboard, a customized surface, a user's lap, etc.

In some implementations, the physical activity surface 116 may be preconfigured for use with a tangible interface object 120. While in further implementations, the activity surface may be any surface on which the tangible interface object 120 may be positioned. It should be understood that while the tangible interface object 120 is presented as a flat object, such as a stick or a ring forming a shape 132, the tangible interface object 120 may be any object that can be physically manipulated and positioned on the physical activity surface 116. In further implementations, the physical activity surface 116 may be configured for creating and/or drawing, such as a notepad, whiteboard, or drawing board.

In some implementations, a shape 132 may be formed out of tangible interface objects 120. The individual tangible interface objects 120 may be positioned as individual component to create a shape 132. For example, the tangible interface components 120 b-d may each be straight sticks that may be positioned to represent the letter “A” depicted as shape 132b. The tangible interface objects 120 may be a variety of shapes including, but not limited to, sticks and rings that may be combined and positioned into a variety of shapes 130 to form letters, numbers, objects, etc. In some implementations, the tangible interface objects 120 may be formed out of a molded plastic, metal, wood, etc. and may be designed to be easily manipulated by children. In some implementations, the tangible interface objects 120 may be a variety of different colors and in further implementations, similar shapes and/or sizes of the tangible interface objects 120 may be grouped into similar colors. In some implementations, the tangible interface objects 120 may be specifically designed to be manipulated by children and may be sized appropriately for a child to quickly and easily position individual tangible interface objects 120 on the physical activity surface 116. In some implementations, the tangible interface objects 120 may include a magnet or other device for magnetic coupling with the physical activity surface 116 in order to assist with positioning and manipulating of the tangible interface object 120.

In some implementations, the physical activity surface may include a border and/or other indicator along the edges of the interaction area. The border and/or other indicator may be visible to a user and may be detectable by the computing device 104 to bound the edges of the physical activity surface 116 within the field-of-view of the camera 110 (not shown).

In some implementations, the physical activity surface 116 may be integrated with a stand 106 that supports the computing device 104 or may be distinct from the stand 106 but placeable adjacent to the stand 106. In some instances, the size of the interactive area on the physical activity surface 116 may be bounded by the field of view of the video capture device 110 (not shown) and can be adapted by an adapter 108 and/or by adjusting the position of the video capture device 110. In additional examples, the boundary and/or other indicator may be a light projection (e.g., pattern, context, shapes, etc.) projected onto the activity surface 102.

In some implementations, the computing device 104 included in the example configuration 100 may be situated on the surface or otherwise proximate to the surface. The computing device 104 can provide the user(s) with a virtual portal for displaying the virtual scene 112. For example, the computing device 104 may be placed on a table in front of a user 130 (not shown) so the user 130 can easily see the computing device 104 while interacting with the tangible interface object 120 on the physical activity surface 116. Example computing devices 104 may include, but are not limited to, mobile phones (e.g., feature phones, smart phones, etc.), tablets, laptops, desktops, netbooks, TVs, set-top boxes, media streaming devices, portable media players, navigation devices, personal digital assistants, etc.

The computing device 104 includes or is otherwise coupled (e.g., via a wireless or wired connection) to a video capture device 110 (also referred to herein as a camera) for capturing a video stream of the physical activity scene. As depicted in FIG. 1 the video capture device 110 (not shown) may be a front-facing camera that is equipped with an adapter 108 that adapts the field of view of the camera 110 to include, at least in part, the physical activity surface 116. For clarity, the physical activity scene of the physical activity surface 116 captured by the video capture device 110 is also interchangeably referred to herein as the activity surface or the activity scene in some implementations.

As depicted in FIG. 1, the computing device 104 and/or the video capture device 110 may be positioned and/or supported by a stand 106. For instance, the stand 106 may position the display of the computing device 104 in a position that is optimal for viewing and interaction by the user who may be simultaneously positioning the tangible interface object 120 and/or interacting with the physical environment. The stand 106 may be configured to rest on the activity surface (e.g., table, desk, etc.) and receive and sturdily hold the computing device 104 so the computing device 104 remains still during use.

In some implementations, the tangible interface object 120 may be used with a computing device 104 that is not positioned in a stand 106 and/or using an adapter 108. The user 130 may position and/or hold the computing device 104 such that a front facing camera or a rear facing camera may capture the tangible interface object 120 and then a virtual scene 112 may be presented on the display of the computing device 104 based on the capture of the tangible interface object 120.

In some implementations, the adapter 108 adapts a video capture device 110 (e.g., front-facing, rear-facing camera) of the computing device 104 to capture substantially only the physical activity surface 116, although numerous further implementations are also possible and contemplated. For instance, the camera adapter 108 can split the field of view of the front-facing camera into two scenes. In this example with two scenes, the video capture device 110 captures a physical activity scene that includes a portion of the activity surface and is able to capture a tangible interface object 120 and/or shape 132 in either portion of the physical activity scene. In another example, the camera adapter 108 can redirect a rear-facing camera of the computing device (not shown) toward a front-side of the computing device 104 to capture the physical activity scene of the activity surface located in front of the computing device 104. In some implementations, the adapter 108 can define one or more sides of the scene being captured (e.g., top, left, right, with bottom open). In some implementations, the camera adapter 108 can split the field of view of the front facing camera to capture both the physical activity scene and the view of the user interacting with the tangible interface object 120. In some implementations, if the user consents to a recording of this split view for privacy concerns, a supervisor (e.g., parent, teacher, etc.) can monitor a user 130 positioning the tangible interface object 120 and provide comments and assistance in real-time. For example, a user 130 may place a first tangible interface object 120b to form a side of the letter “A” and it may not be touching the other parts of the tangible interface objects 120c and 120d. A parent can guide the user 130 (such as a younger child) to move the tangible interface object 120b until it comes into contact with the ends of the tangible interface objects 120c and 120d and the letter “A” 130b is formed. In further implementations, the split view may allow for real-time interactions, such as a tutor that is assisting remotely and can see both the user 130 in one portion of the view and the physical activity surface 116 in another. The tutor can see a look of confusion on the user's 130 face and can see right where the user is stuck in forming a shape 132 in order to assist the user 130 in positioning the tangible interface object 120.

The adapter 108 and stand 106 for a computing device 104 may include a slot for retaining (e.g., receiving, securing, gripping, etc.) an edge of the computing device 104 to cover at least a portion of the camera 110. The adapter 108 may include at least one optical element (e.g., a mirror) to direct the field of view of the camera 110 toward the activity surface. The computing device 104 may be placed in and received by a compatibly sized slot formed in a top side of the stand 106. The slot may extend at least partially downward into a main body of the stand 106 at an angle so that when the computing device 104 is secured in the slot, it is angled back for convenient viewing and utilization by its user or users. The stand 106 may include a channel formed perpendicular to and intersecting with the slot. The channel may be configured to receive and secure the adapter 108 when not in use. For example, the adapter 108 may have a tapered shape that is compatible with and configured to be easily placeable in the channel of the stand 106. In some instances, the channel may magnetically secure the adapter 108 in place to prevent the adapter 108 from being easily jarred out of the channel. The stand 106 may be elongated along a horizontal axis to prevent the computing device 104 from tipping over when resting on a substantially horizontal activity surface (e.g., a table). The stand 106 may include channeling for a cable that plugs into the computing device 104. The cable may be configured to provide power to the computing device 104 and/or may serve as a communication link to other computing devices, such as a laptop or other personal computer.

In some implementations, the adapter 108 may include one or more optical elements, such as mirrors and/or lenses, to adapt the standard field of view of the video capture device 110. For instance, the adapter 108 may include one or more mirrors and lenses to redirect and/or modify the light being reflected from activity surface into the video capture device 110. As an example, the adapter 108 may include a mirror angled to redirect the light reflected from the activity surface in front of the computing device 104 into a front-facing camera of the computing device 104. As a further example, many wireless handheld devices include a front-facing camera with a fixed line of sight with respect to the display of the computing device 104. The adapter 108 can be detachably connected to the device over the camera 110 to augment the line of sight of the camera 110 so it can capture the activity surface (e.g., surface of a table, etc.). The mirrors and/or lenses in some implementations can be polished or laser quality glass. In other examples, the mirrors and/or lenses may include a first surface that is a reflective element. The first surface can be a coating/thin film capable of redirecting light without having to pass through the glass of a mirror and/or lens. In an alternative example, a first surface of the mirrors and/or lenses may be a coating/thin film and a second surface may be a reflective element. In this example, the lights passes through the coating twice, however since the coating is extremely thin relative to the glass, the distortive effect is reduced in comparison to a conventional mirror. This mirror reduces the distortive effect of a conventional mirror in a cost effective way.

In another example, the adapter 108 may include a series of optical elements (e.g., mirrors) that wrap light reflected off of the activity surface located in front of the computing device 104 into a rear-facing camera of the computing device 104 so it can be captured. The adapter 108 could also adapt a portion of the field of view of the video capture device 110 (e.g., the front-facing camera) and leave a remaining portion of the field of view unaltered so that multiple scenes may be captured by the video capture device 110. The adapter 108 could also include optical element(s) that are configured to provide different effects, such as enabling the video capture device 110 to capture a greater portion of the activity surface 102. For example, the adapter 108 may include a convex mirror that provides a fisheye effect to capture a larger portion of the activity surface than would otherwise be capturable by a standard configuration of the video capture device 110.

The video capture device 110 could, in some implementations, be an independent unit that is distinct from the computing device 104 and may be positionable to capture the activity surface or may be adapted by the adapter 108 to capture the activity surface as discussed above. In these implementations, the video capture device 110 may be communicatively coupled via a wired or wireless connection to the computing device 104 to provide it with the video stream being captured.

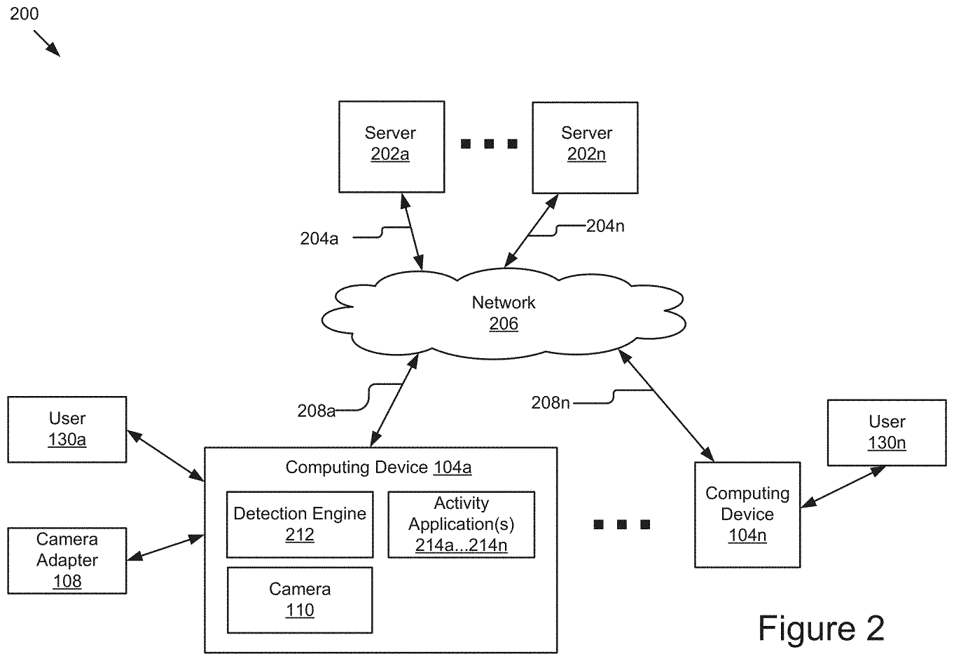

FIG. 2 is a block diagram illustrating an example computer system 200 for virtualization of tangible object components. The illustrated system 200 includes computing devices 104a . . . 104n (also referred to individually and collectively as 104) and servers 202a . . . 202n (also referred to individually and collectively as 202), which are communicatively coupled via a network 206 for interaction with one another. For example, the computing devices 104a . . . 104n may be respectively coupled to the network 206 via signal lines 208a . . . 208n and may be accessed by users 130a . . . 130n (also referred to individually and collectively as 130). The servers 202a . . . 202n may be coupled to the network 206 via signal lines 204a . . . 204n, respectively. The use of the nomenclature “a” and “n” in the reference numbers indicates that any number of those elements having that nomenclature may be included in the system 200.

The network 206 may include any number of networks and/or network types. For example, the network 206 may include, but is not limited to, one or more local area networks (LANs), wide area networks (WANs) (e.g., the Internet), virtual private networks (VPNs), mobile (cellular) networks, wireless wide area network (WWANs), WiMAX® networks, Bluetooth® communication networks, peer-to-peer networks, other interconnected data paths across which multiple devices may communicate, various combinations thereof, etc.

The computing devices 104a . . . 104n (also referred to individually and collectively as 104) are computing devices having data processing and communication capabilities. For instance, a computing device 104 may include a processor (e.g., virtual, physical, etc.), a memory, a power source, a network interface, and/or other software and/or hardware components, such as front and/or rear facing cameras, display, graphics processor, wireless transceivers, keyboard, camera, sensors, firmware, operating systems, drivers, various physical connection interfaces (e.g., USB, HDMI, etc.). The computing devices 104a . . . 104n may couple to and communicate with one another and the other entities of the system 200 via the network 206 using a wireless and/or wired connection. While two or more computing devices 104 are depicted in FIG. 2, the system 200 may include any number of computing devices 104. In addition, the computing devices 104a . . . 104n may be the same or different types of computing devices.

As depicted in FIG. 2, one or more of the computing devices 104a . . . 104n may include a camera 110, a detection engine 212, and activity application(s) 214. One or more of the computing devices 104 and/or cameras 110 may also be equipped with an adapter 108 as discussed elsewhere herein. The detection engine 212 is capable of detecting and/or recognizing the shape 132 formed out of one or more tangible interface object(s) 120 by identifying a combined position of each tangible interface object 120 relative to other tangible interface object(s) 120. The detection engine 212 can detect the position and orientation of each of the tangible interface object(s) 120, detect how the shape 132 is being formed and/or manipulated by the user 130, and cooperate with the activity application(s) 214 to provide users 130 with a rich virtual experience by detecting the tangible interface object 120 and generating a virtualization in the virtual scene 112.

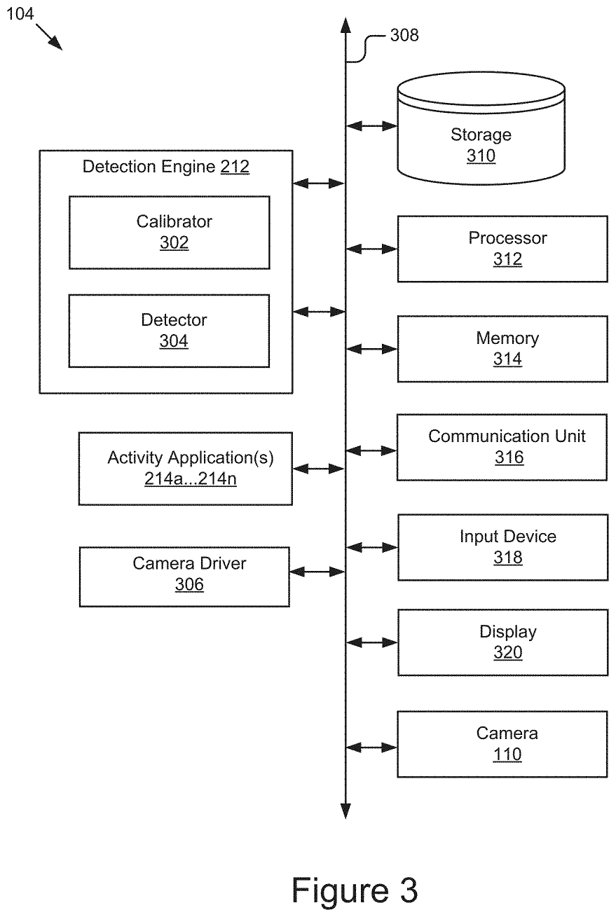

In some implementations, the detection engine 212 processes video captured by a camera 110 to detect visual markers and/or other identifying elements or characteristics to identify the tangible interface object(s) 120. The activity application(s) 214 are capable of determining a shape 132 and generating a virtualization. Additional structure and functionality of the computing devices 104 are described in further detail below with reference to at least FIG. 3.

The servers 202 may each include one or more computing devices having data processing, storing, and communication capabilities. For example, the servers 202 may include one or more hardware servers, server arrays, storage devices and/or systems, etc., and/or may be centralized or distributed/cloud-based. In some implementations, the servers 202 may include one or more virtual servers, which operate in a host server environment and access the physical hardware of the host server including, for example, a processor, memory, storage, network interfaces, etc., via an abstraction layer (e.g., a virtual machine manager).

The servers 202 may include software applications operable by one or more computer processors of the servers 202 to provide various computing functionalities, services, and/or resources, and to send data to and receive data from the computing devices 104. For example, the software applications may provide functionality for internet searching; social networking; web-based email; blogging; micro-blogging; photo management; video, music and multimedia hosting, distribution, and sharing; business services; news and media distribution; user account management; or any combination of the foregoing services. It should be understood that the servers 202 are not limited to providing the above-noted services and may include other network-accessible services.

It should be understood that the system 200 illustrated in FIG. 2 is provided by way of example, and that a variety of different system environments and configurations are contemplated and are within the scope of the present disclosure. For instance, various functionality may be moved from a server to a client, or vice versa and some implementations may include additional or fewer computing devices, services, and/or networks, and may implement various functionality client or server-side. Further, various entities of the system 200 may be integrated into a single computing device or system or additional computing devices or systems, etc.

FIG. 3 is a block diagram of an example computing device 104. As depicted, the computing device 104 may include a processor 312, memory 314, communication unit 316, display 320, camera 110, and an input device 318, which are communicatively coupled by a communications bus 308. However, it should be understood that the computing device 104 is not limited to such and may include other elements, including, for example, those discussed with reference to the computing devices 104 in FIGS. 1, 4A-4D, 5A-5E, 6A-6D, and 7.

The processor 312 may execute software instructions by performing various input/output, logical, and/or mathematical operations. The processor 312 has various computing architectures to process data signals including, for example, a complex instruction set computer (CISC) architecture, a reduced instruction set computer (RISC) architecture, and/or an architecture implementing a combination of instruction sets. The processor 312 may be physical and/or virtual, and may include a single core or plurality of processing units and/or cores.

The memory 314 is a non-transitory computer-readable medium that is configured to store and provide access to data to the other elements of the computing device 104. In some implementations, the memory 314 may store instructions and/or data that may be executed by the processor 312. For example, the memory 314 may store the detection engine 212, the activity application(s) 214, and the camera driver 306. The memory 314 is also capable of storing other instructions and data, including, for example, an operating system, hardware drivers, other software applications, data, etc. The memory 314 may be coupled to the bus 308 for communication with the processor 312 and the other elements of the computing device 104.

The communication unit 316 may include one or more interface devices (I/F) for wired and/or wireless connectivity with the network 206 and/or other devices. In some implementations, the communication unit 316 may include transceivers for sending and receiving wireless signals. For instance, the communication unit 316 may include radio transceivers for communication with the network 206 and for communication with nearby devices using close-proximity (e.g., Bluetooth®, NFC, etc.) connectivity. In some implementations, the communication unit 316 may include ports for wired connectivity with other devices. For example, the communication unit 316 may include a CAT-5 interface, Thunderbolt™ interface, FireWire™ interface, USB interface, etc.

The display 320 may display electronic images and data output by the computing device 104 for presentation to a user 130. The display 320 may include any conventional display device, monitor or screen, including, for example, an organic light-emitting diode (OLED) display, a liquid crystal display (LCD), etc. In some implementations, the display 320 may be a touch-screen display capable of receiving input from one or more fingers of a user 130. For example, the display 320 may be a capacitive touch-screen display capable of detecting and interpreting multiple points of contact with the display surface. In some implementations, the computing device 104 may include a graphics adapter (not shown) for rendering and outputting the images and data for presentation on display 320. The graphics adapter (not shown) may be a separate processing device including a separate processor and memory (not shown) or may be integrated with the processor 312 and memory 314.

The input device 318 may include any device for inputting information into the computing device 104. In some implementations, the input device 318 may include one or more peripheral devices. For example, the input device 318 may include a keyboard (e.g., a QWERTY keyboard), a pointing device (e.g., a mouse or touchpad), microphone, a camera, etc. In some implementations, the input device 318 may include a touch-screen display capable of receiving input from the one or more fingers of the user 130. For instance, the functionality of the input device 318 and the display 320 may be integrated, and a user 130 of the computing device 104 may interact with the computing device 104 by contacting a surface of the display 320 using one or more fingers. In this example, the user 130 could interact with an emulated (i.e., virtual or soft) keyboard displayed on the touch-screen display 320 by using fingers to contact the display 320 in the keyboard regions.

The detection engine 212 may include a detector 304. The elements 212 and 304 may be communicatively coupled by the bus 308 and/or the processor 312 to one another and/or the other elements 214, 306, 310, 314, 316, 318, 320, and/or 110 of the computing device 104. In some implementations, one or more of the elements 212 and 304 are sets of instructions executable by the processor 312 to provide their functionality. In some implementations, one or more of the elements 212 and 304 are stored in the memory 314 of the computing device 104 and are accessible and executable by the processor 312 to provide their functionality. In any of the foregoing implementations, these components 212, and 304 may be adapted for cooperation and communication with the processor 312 and other elements of the computing device 104.

The detector 304 includes software and/or logic for processing the video stream captured by the camera 110 to detect and/or identify one or more tangible interface object(s) 120 included in the video stream. In some implementations, the detector 304 may identify line segments and/or circles related to tangible interface object(s) 120 and/or visual markers included in the tangible interface object(s) 120. In some implementations, the detector 304 may be coupled to and receive the video stream from the camera 110, the camera driver 306, and/or the memory 314. In some implementations, the detector 304 may process the images of the video stream to determine positional information for the line segments related to the tangible interface object(s) 120 and/or formation of a tangible interface object 120 into a shape 132 on the physical activity surface 116 (e.g., location and/or orientation of the line segments in 2D or 3D space) and then analyze characteristics of the line segments included in the video stream to determine the identities and/or additional attributes of the line segments.

In some implementations, the detector 304 may use visual characteristics to recognize custom designed portions of the physical activity surface 116, such as corners or edges, etc. The detector 304 may perform a straight line detection algorithm and a rigid transformation to account for distortion and/or bends on the physical activity surface 116. In some implementations, the detector 304 may match features of detected line segments to a reference object that may include a depiction of the individual components of the reference object in order to determine the line segments and/or the boundary of the expected objects in the physical activity surface 116. In some implementations, the detector 304 may account for gaps and/or holes in the detected line segments and/or contours and may be configured to generate a mask to fill in the gaps and/or holes.

In some implementations, the detector 304 may recognize the line by identifying its contours. The detector 304 may also identify various attributes of the line, such as colors, contrasting colors, depth, texture, etc. In some implementations, the detector 304 may use the description of the line and the lines attributes to identify a tangible interface object 120 by comparing the description and attributes to a database of virtual objects and identifying the closest matches by comparing recognized tangible interface object(s) 120 to reference components of the virtual objects. In some implementations, the detector 304 may incorporate machine learning algorithms to add additional virtual objects to a database of virtual objects as new shapes are identified. For example, as children make consistent mistakes in creating shape 132 using the tangible interface objects 120, the detector 304 may use the machine learning to recognize the consistent mistakes and add these updated objects to the virtual object database for future identification and/or recognition.

The detector 304 may be coupled to the storage 310 via the bus 308 to store, retrieve, and otherwise manipulate data stored therein. For example, the detector 304 may query the storage 310 for data matching any line segments that it has determined are present in the interactive page 116. In all of the above descriptions, the detector 304 may send the detected images to the detection engine 212 and the detection engine 212 may perform the above described features.

The detector 304 may be able to process the video stream to detect a manipulation of the tangible interface object 120. In some implementations, the detector 304 may be configured to understand relational aspects between a tangible interface object 120 and determine an interaction based on the relational aspects. For example, the detector 304 may be configured to identify an interaction related to one or more tangible interface object present in the physical activity surface 116 and the activity application(s) 214 may determine a routine based on the relational aspects between the one or more tangible interface object(s) 120 and other elements of the physical activity surface 116.

The activity application(s) 214 include software and/or logic for identifying one or more tangible interface object(s) 120, identifying a combined position of the tangible interface object(s) 120 relative to each other, determine a virtual object based on the combined position and/or the shape being formed by the tangible interface object(s) 120, and display the virtual object 122 in the virtual scene 112. The activity application(s) 214 may be coupled to the detector 304 via the processor 312 and/or the bus 308 to receive the information. For example, a user 130 may form a shape 132 out of individual tangible interface object(s) 120 and the activity application(s) 214 may determine what the shape 132 represents and/or if that shape is correct based on a prompt or cue displayed in the virtual scene 112.

In some implementations, the activity application(s) 214 may determine the virtual object 122 and/or a routine by searching through a database of virtual objects and/or routines that are compatible with the identified combined position of tangible interface object(s) 120 relative to each other. In some implementations, the activity application(s) 214 may access a database of virtual objects or routines stored in the storage 310 of the computing device 104. In further implementations, the activity application(s) 214 may access a server 202 to search for virtual objects and/or routines. In some implementations, a user 130 may predefine a virtual object and/or routine to include in the database.

In some implementations, the activity application(s) 214 may enhance the virtual scene and/or the virtual object 122 as part of a routine. For example, the activity application(s) 214 may display visual enhancements as part of executing the routine. The visual enhancements may include adding color, extra virtualizations, background scenery, incorporating the virtual object 122 into a shape and/or character, etc. In further implementations, the visual enhancements may include having the virtual object 122 move or interact with another virtualization (not shown) and/or the virtual character 124 in the virtual scene. In some implementations, the activity application(s) 214 may prompt the user 130 to select one or more enhancement options, such as a change to color, size, shape, etc. and the activity application(s) 214 may incorporate the selected enhancement options into the virtual object 122 and/or the virtual scene 112.

In some instances, the shape 132 formed by the individual tangible interface object(s) 120 positioned by the user 130 on the physical activity surface 116 may be incrementally presented in the virtual scene 112 as the user 130 interacts. For example, as a user positions additional tangible interface object(s) 120, such as sticks and/or rings, the additional tangible interface object(s) 120, such as sticks and/or rings, may be presented in the virtual scene 112 in substantially real-time. Non-limiting examples of the activity applications 214 may include video games, learning applications, assistive applications, storyboard applications, collaborative applications, productivity applications, etc.

The camera driver 306 includes software storable in the memory 314 and operable by the processor 312 to control/operate the camera 110. For example, the camera driver 306 is a software driver executable by the processor 312 for signaling the camera 110 to capture and provide a video stream and/or still image, etc. The camera driver 306 is capable of controlling various features of the camera 110 (e.g., flash, aperture, exposure, focal length, etc.). The camera driver 306 may be communicatively coupled to the camera 110 and the other components of the computing device 104 via the bus 308, and these components may interface with the camera driver 306 via the bus 308 to capture video and/or still images using the camera 110.

As discussed elsewhere herein, the camera 110 is a video capture device configured to capture video of at least the activity surface 102. The camera 110 may be coupled to the bus 308 for communication and interaction with the other elements of the computing device 104. The camera 110 may include a lens for gathering and focusing light, a photo sensor including pixel regions for capturing the focused light and a processor for generating image data based on signals provided by the pixel regions. The photo sensor may be any type of photo sensor including a charge-coupled device (CCD), a complementary metal-oxide-semiconductor (CMOS) sensor, a hybrid CCD/CMOS device, etc. The camera 110 may also include any conventional features such as a flash, a zoom lens, etc. The camera 110 may include a microphone (not shown) for capturing sound or may be coupled to a microphone included in another component of the computing device 104 and/or coupled directly to the bus 308. In some implementations, the processor of the camera 110 may be coupled via the bus 308 to store video and/or still image data in the memory 314 and/or provide the video and/or still image data to other elements of the computing device 104, such as the detection engine 212 and/or activity application(s) 214.

The storage 310 is an information source for storing and providing access to stored data, such as a database of virtual objects, virtual prompts, routines, and/or virtual elements, gallery(ies) of virtual objects that may be displayed on the display 320, user profile information, community developed virtual routines, virtual enhancements, etc., object data, calibration data, and/or any other information generated, stored, and/or retrieved by the activity application(s) 214.

In some implementations, the storage 310 may be included in the memory 314 or another storage device coupled to the bus 308. In some implementations, the storage 310 may be or included in a distributed data store, such as a cloud-based computing and/or data storage system. In some implementations, the storage 310 may include a database management system (DBMS). For example, the DBMS could be a structured query language (SQL) DBMS. For instance, storage 310 may store data in an object-based data store or multi-dimensional tables comprised of rows and columns, and may manipulate, i.e., insert, query, update, and/or delete, data entries stored in the verification data store using programmatic operations (e.g., SQL queries and statements or a similar database manipulation library). Additional characteristics, structure, acts, and functionality of the storage 310 is discussed elsewhere herein.

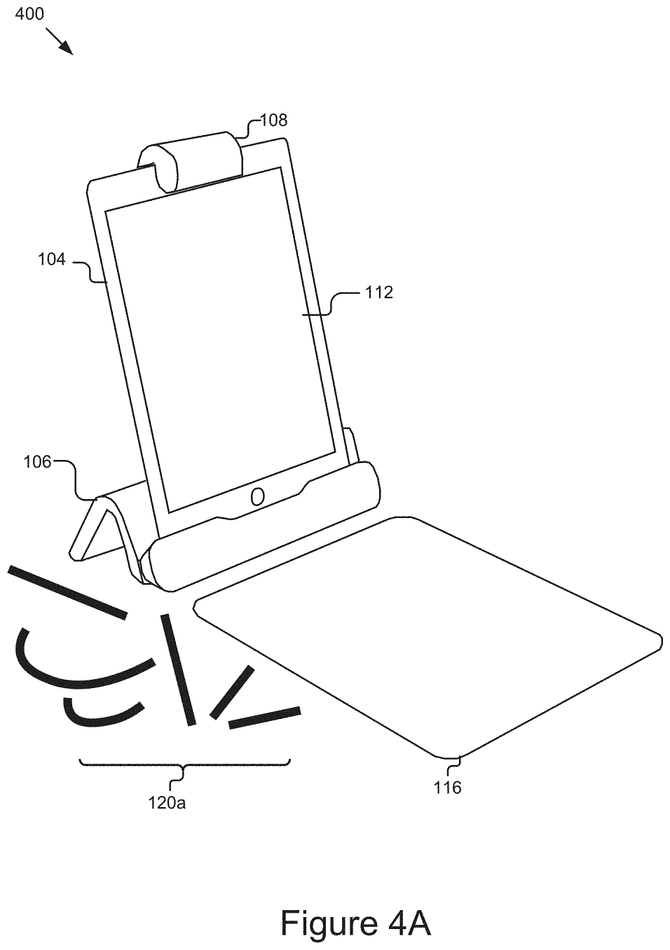

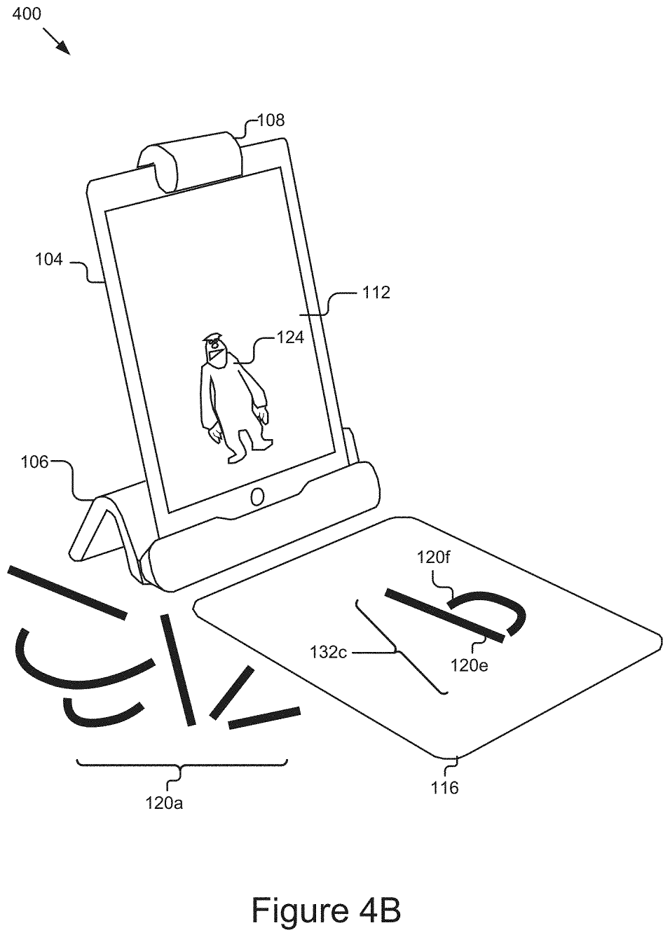

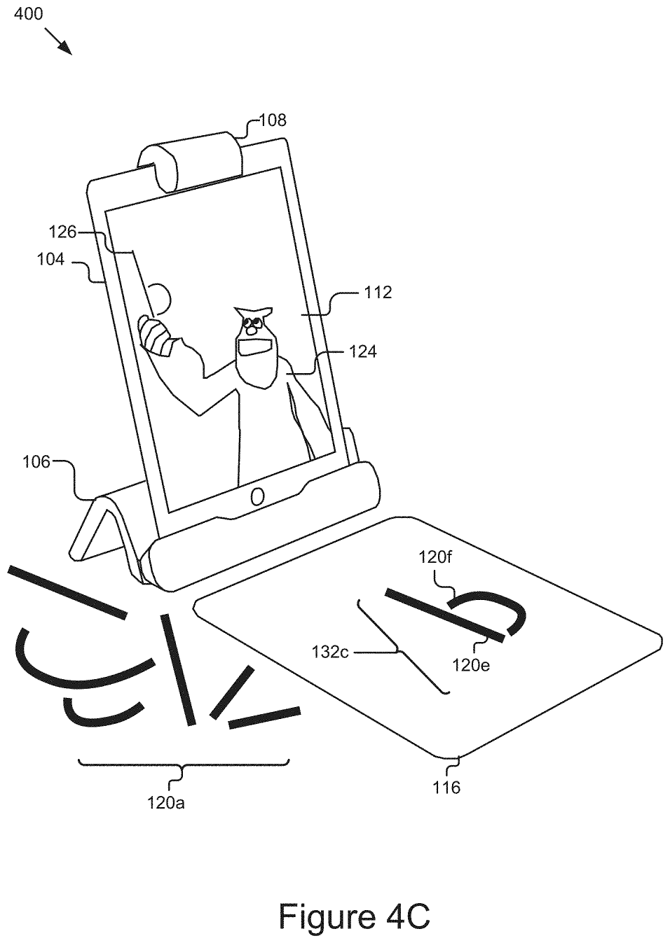

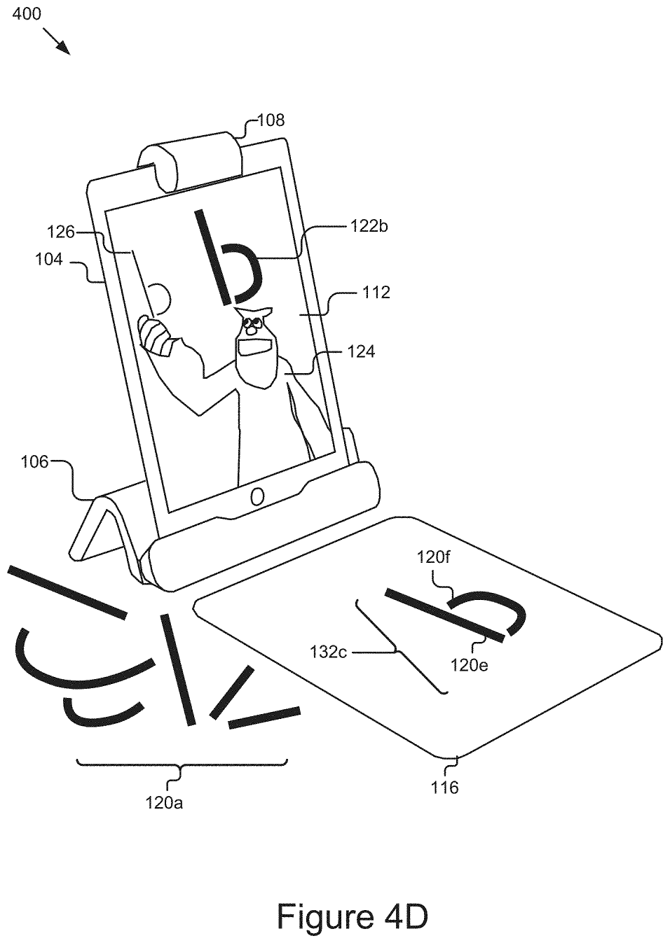

FIGS. 4A-4D depict an example configuration 400 for virtualization of tangible object components. As shown in the example configuration 400 in FIG. 4A, a user 130 (not shown) may interact with the tangible interface object(s) 120a shown adjacent to the physical activity surface 116. In some implementations, the tangible interface object(s) 120a may be an assortment of sticks and rings of various sizes, lengths, and/or curves that a user 130 may individually place on the physical activity surface 120a. In some implementations, the video capture device 110 and/or the detector 304 may ignore or be unable to view the tangible interface object(s) 120a when they are not placed within the boundary of the physical activity surface 116.

In some implementations, the activity application(s) 214 may execute a routine that causes an animation and/or a virtual character 124 to be displayed in the virtual scene 112, as shown in FIG. 4B. In some implementations, the virtual character 124 may prompt the user 130 to create an object 132c out of the tangible interface object(s) 120a. In further implementations, the virtual character 124 may wait for a user 130 to freely create an object 132c and then the virtual character 124 may interact with a virtualization of the object 132c once the user 130 has completed the positioning of the tangible interface object(s) 120a. The activity application(s) 214 may determine that the user 130 has completed the positioning of the tangible interface object(s) 120a when motion has not been detected for a period of time and/or a user 130 has selected a completed icon displayed on the graphical user interface.

As shown in the example in FIG. 4B, an object 132c depicting the lowercase letter “b” has been created by positioning a first tangible interface object 120e represented as a straight stick and a second tangible interface object 120f represented as a small half ring. The activity application(s) 214 and/or the detector 304 may identify the position of the tangible interface objects 120e and 120f relative to each other and determine that the intended object 132c is the lowercase letter “b”. By determining the combined position of the first tangible interface object 120e relative to the second tangible interface object 120f, a user 130 is not limited in where the tangible interface objects 120e and 120f are positioned on the physical activity surface 116, only that the shape 132c formed out of the combined position of the two tangible interface objects 120e and 120f matches with a virtual object depicting the lowercase letter “b”.

In some implementations, a routine may be executed by the activity application(s) 214 causing the virtual character 124 to reach down to the bottom of the display screen and appear to pull a virtualization of the object 132c up into the graphical user interface. In further implementations, as shown in FIG. 4C, the virtual character 124 may appear to hold and/or present a virtual prompt 126 depicting the object 132c. In some implementations, the virtual prompt 126 may precede the positioning of the tangible interface object(s) 120e and/or 120f and the user 130 may use the virtual prompt 126 to identify what type of object 132c to create out of the tangible interface object(s) 120. As shown in FIG. 4D, in some implementations, a virtualization 122b of the object 132c may also appear on the screen and allow the user to compare a virtualization 122b of their object 132c to the virtual prompt 126 that they were patterning the object 132c after. In some implementations, the virtual prompt 126 may include colors and/or other characteristics to help guide the user 130 as to which tangible interface object(s) 120 should be used to form the object 132c. In further implementations, a user 130 may position different tangible interface object(s) such as a larger stick and/or a wider half-ring and still create an object 132c that could be interpreted as a lowercase “b” by the activity application(s) 214. The activity application(s) 214 may provide game functionality and score the object(s) 132 created by the user 130 and in some implementations award additional incentives for identifying alternative configurations of tangible interface object(s) 120 that achieve a similar virtual object 122b configuration.

These simple applications of using the virtual prompt 126 may be especially beneficial for younger children that are learning how the shapes of letters, numbers, and/or objects are being formed using sticks and rings. The children may be able to freely incorporate their creativity into the creation of the objects 132 and expand their opportunities to learn about how different letters, numbers, and/or objects may be formed using the stick and ring tangible interface object(s) 120. By using a physical medium in the form of the tangible interface object(s) 120 in conjunction with the digital virtualizations and applications, a child may have tactile and tangible immersiveness in an educational experience that expands their learning and understanding of concepts as compared to merely using a digital medium to teach.

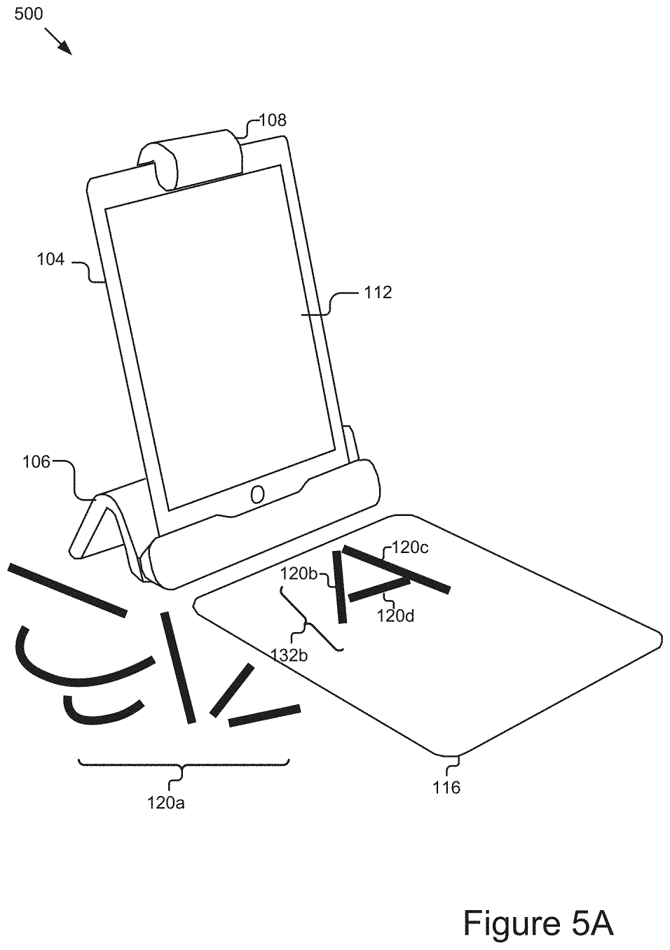

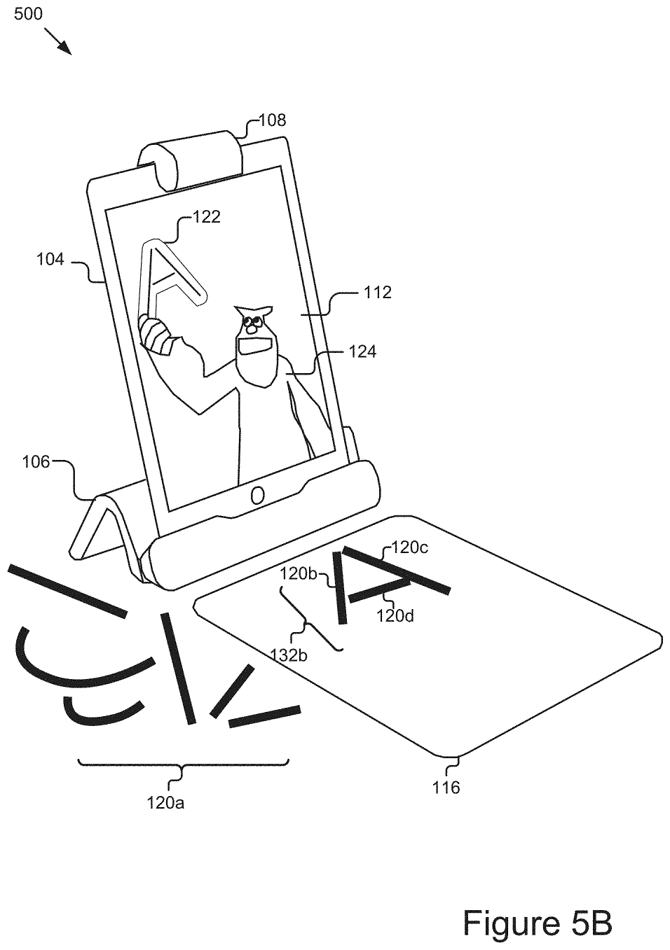

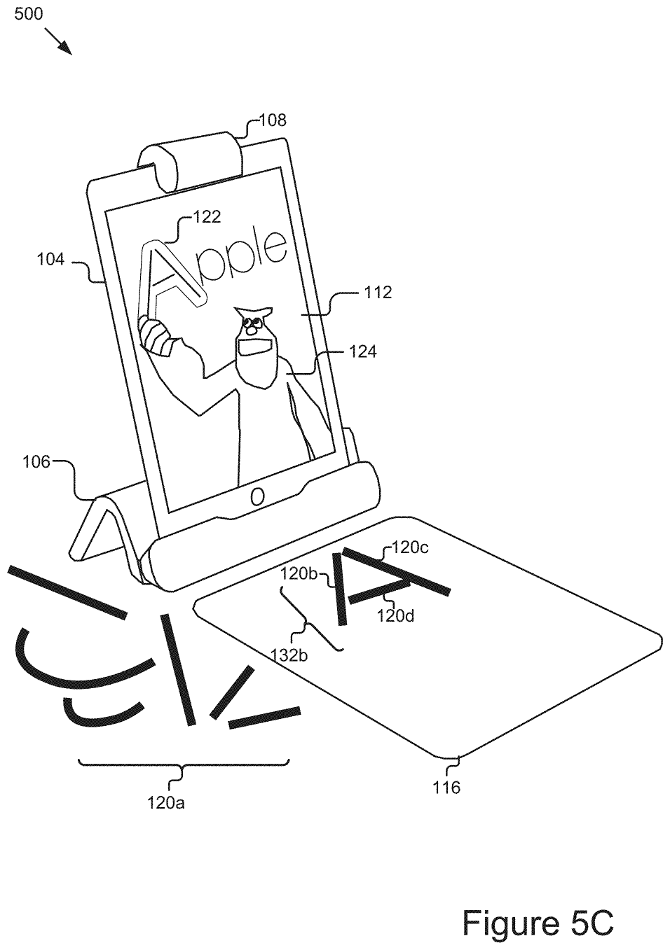

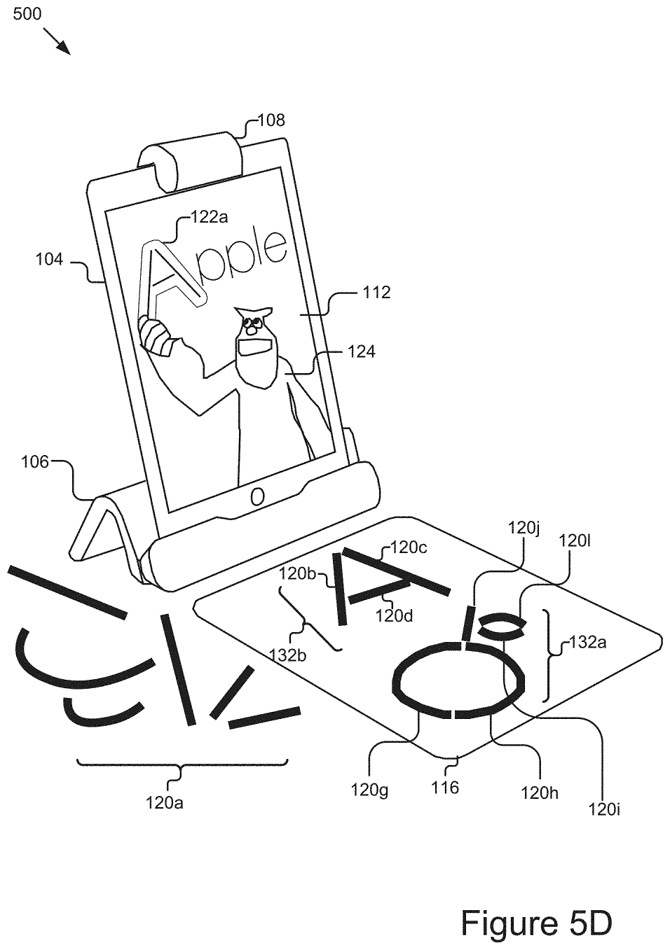

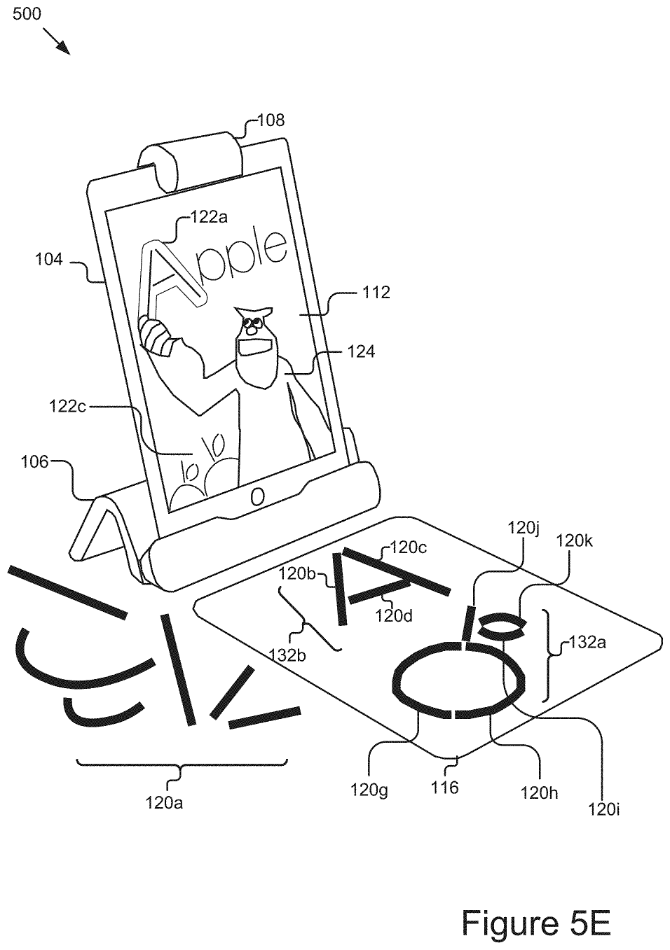

FIGS. 5A-5E depict an example configuration 500 using a virtualization of tangible object components. As shown in FIG. 5A and described with respect to FIG. 1, a user 130 (not shown) may position multiple tangible interface object(s) 120b-d to form an object 132b on the physical activity surface 116. The detector 304 may identify the positions of each of the tangible interface object(s) 120b-d in the captured video stream and the combined position of the object 132b with the relative positions of each of the tangible interface object(s) 120b-d. In some implementations, the detector 304 and/or the activity application(s) 214 may identify a position and/or an orientation of each of the tangible interface object(s) 120b-d and may match those individual positions and orientations of each of the tangible interface object(s) 120b-d relative to each other to a database of virtual objects and the reference components of each of the virtual objects in order to identify a virtual object 122 represented by the object 132b.

As shown in FIG. 5B, once the virtual object 122 has been matched to the object 132b, the activity application(s) 214 may execute a routine and/or an animation the causes the virtual object 122 to be presented for display on the graphical user interface. For example, the virtual character 122 may appear to be holding the virtual object 122. In further implementations, the virtual object 122 may be presented as a prompt for the user to create that object using the tangible interface object(s) 120. As shown in FIG. 5C, additional educational concepts may be presented by the activity application(s) 214, such as spelling out a word that uses the letter “A” represented by the object 132b in order to teach a user 130 how the object 132b relates to a word and how it sounds.

It should be understood that the tangible interface object(s) 120 may be positioned to form more than just letters. As show in FIG. 5D, the sticks and rings used as tangible interface object(s) 120 may be positioned relative to each other to form all sorts of objects 132 in a free-play environment that expands creativity. For example, as shown in FIG. 5D, after a user 130 has created the object 132b depicting the letter “A”, the user 130 may create an object 132a representing an apple by combing various sizes of half-circle rings and a straight stick represented by tangible interface object(s) 120g-1201. In some implementations, a prompt may appear on the display in the virtual scene 112 showing how a user may form the object 132. As shown in FIG. 5E, in some implementations, the object 132 may be a new object 132a as shown and both objects 132a and 132b may be present on the physical activity surface 116 at the same time and similar virtual objects 122a and 122c may be present in the virtual scene 112 at the same time. This may allow a user 130 to position related objects 132b and 132a on the physical activity surface 116 and expand on the objects 132a and 132b relationship in the virtual scene 112. The detector 304 may identify the second object 132a, such as the apple in this example, as a new object and present in the virtual scene 112 a new virtual object 122c.

In some implementations, the virtual object 122c may be displayed before the user 130 positions the tangible interface object(s) 120g-120k to create the object 132a. The virtual object 122c may act as a virtual prompt representing the object 132a for the user 120 to create in the physical activity scene 116 using the tangible interface object(s) 120g-120k. The detector 304 may detect in the video stream the placement of one or more of the tangible interface object(s) 120g-120k and determine that the combined position of the tangible interface object(s) 120g-120k relative to each other matches an expected virtual object based on the displayed virtual prompt. If the created object 132a matches the expected virtual object, then the activity application(s) 214 may cause a correct animation to be presented on the display screen, such as a score, progression meter, or other incentive for the user 130.

In some implementations, when a virtual prompt is displayed, such as a virtual object 122 on the display screen, the activity application(s) 214 may cause a highlighting of at least a portion of the virtual prompt to be presented in the virtual scene 112. The highlighting of the virtual prompt may signal a shape of one or more of the tangible interface object(s) 120 that may be used to create the represented object 132 on the physical activity scene. For example, if the user is struggling to identify the stem piece created by the tangible interface object 120j, then the virtual prompt may cause the stem piece to be highlighted in the color of the tangible interface object 120j in order to guide the user to the appropriate tangible interface object 120j to create the stem piece.

In further implementations, if the activity application(s) 214 determines that a tangible interface object 120 is positioned incorrectly in order to match a specific virtual object, then the activity application(s) 214 may cause additional highlighting that signals the correct placement of one or more of the tangible interface object(s) 120 in the graphical user interface. Additional highlighting and/or other hints may be presented to the user 130 in order to assist the user 130 in appropriately positioning the tangible interface objects 120 to create the object 132 depicted by the virtual prompt. By providing the real-time feedback to assist the user 130, the knowledge and understanding of how the objects 132 are formed using the tangible interface objects 120 is increased.

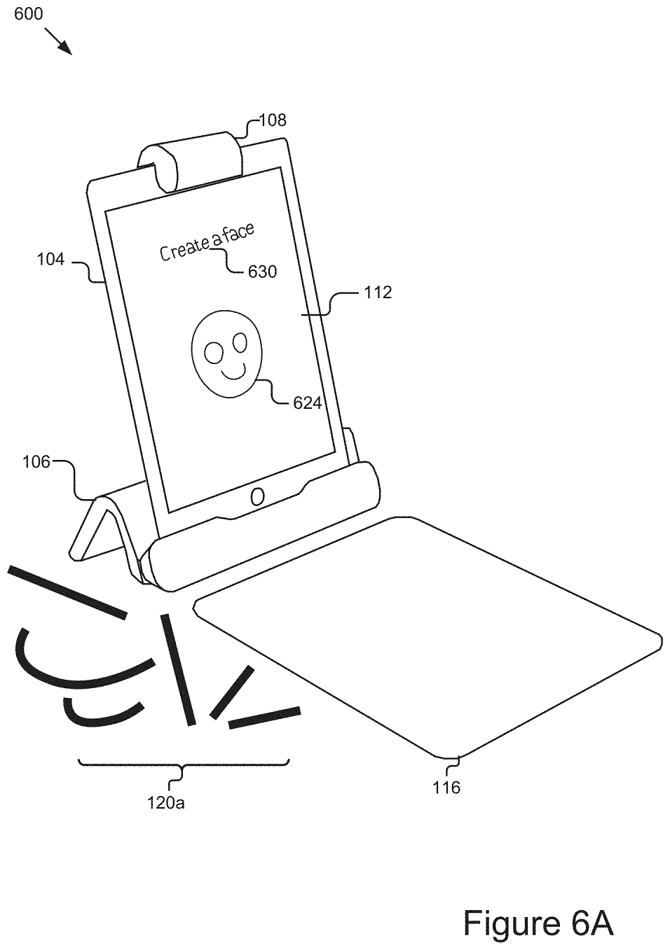

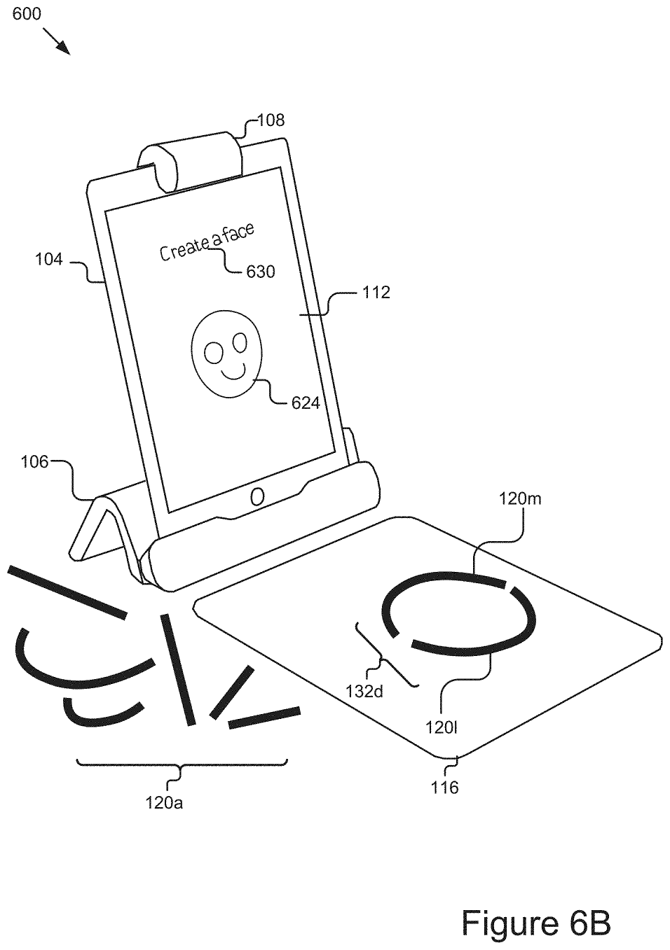

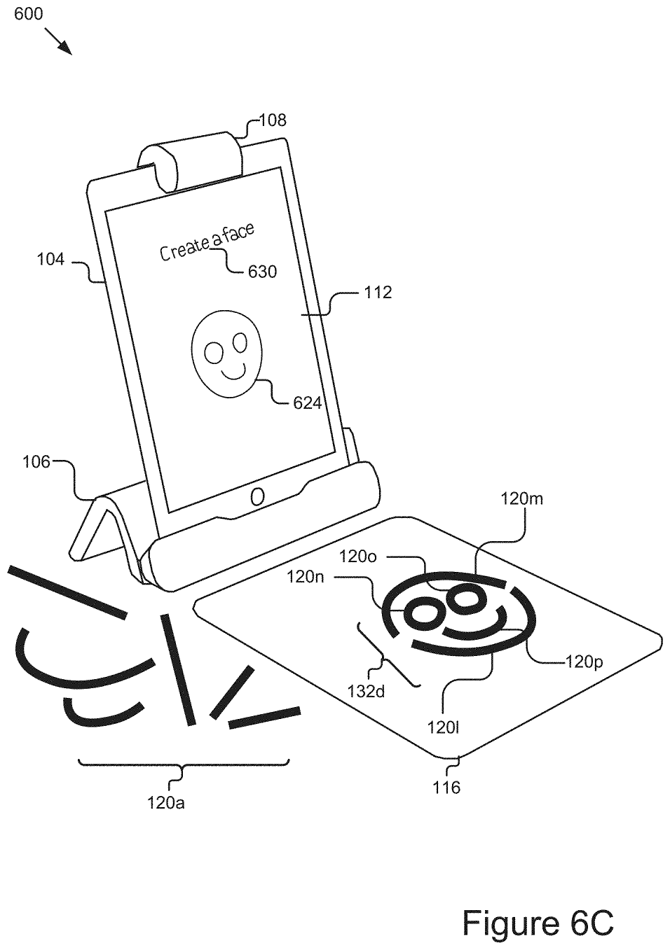

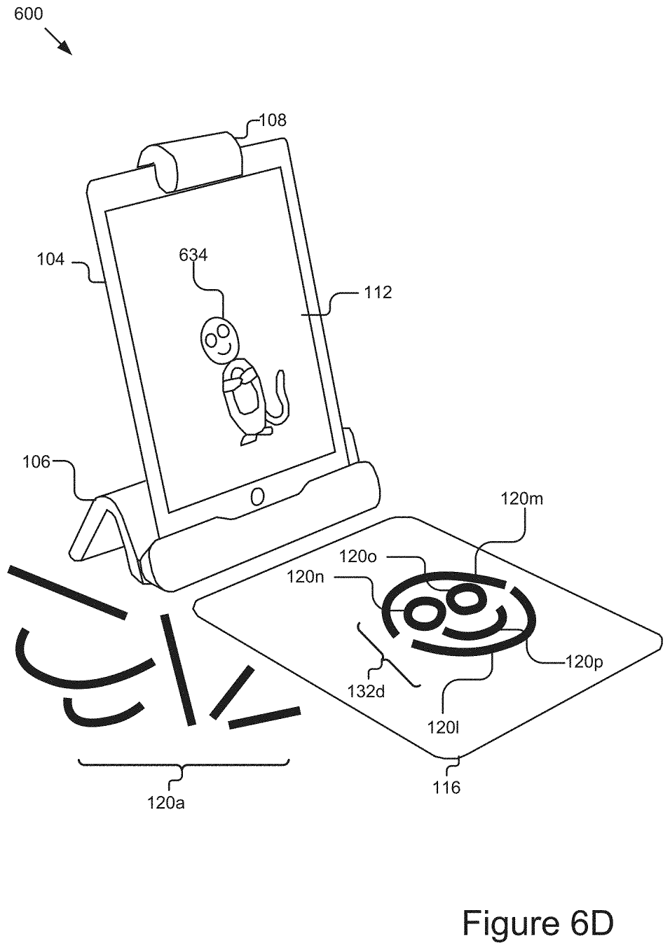

FIGS. 6A-6D depict an example configuration 600 for using a virtualization of tangible object components. As shown in the example configuration 600 in FIG. 6A, a virtual prompt 630 may be presented in the virtual scene 112. In some implementations, the virtual prompt 630 may instruct a user 130 to “create a face” and or other prompts based on the activities being executed by the activity application(s) 214. In further implementations, the virtual scene 112 may include a visualization 624 illustrating an example representation of the object that the user 130 may create.

As shown in FIG. 6B, the user 130 may being positioning tangible interface object(s) 1201-120m in order to begin creating the object 132d depicted by the visualization 624. In some implementations, the activity application(s) 214 may wait for the user 130 to complete the positioning of the tangible interface object(s) 1201-120m before proceeding. In further implementations, the activity application(s) 214 may present a real-time virtualization depicting the placement of the tangible interface object(s) 120.

As shown in FIG. 6C, once the user has placed all of the tangible interface object(s) 1201-120p in order to create the object 132d depicting a “smiley face” then the activity application(s) 214 may proceed to the next step of the application. As shown in FIG. 6D, in some implementations, after the object 132d has been completed, then a virtualization 634 that incorporates the object may be presented in the virtual scene 112. This may allow the user 130 to connect with their physical object 132 and interact with the virtualization 634 in the virtual scene 112. For example, once the object 132d has been formed, a spinning wheel may appear for the user to select an option on, and if the user selects a “cat” option, then the “smiley face” depicted by the object 132d may have a virtualization 634 generated that incorporates the features and/or characteristics of the object 132d formed out of the one or more tangible interface object(s) 1201-120p.

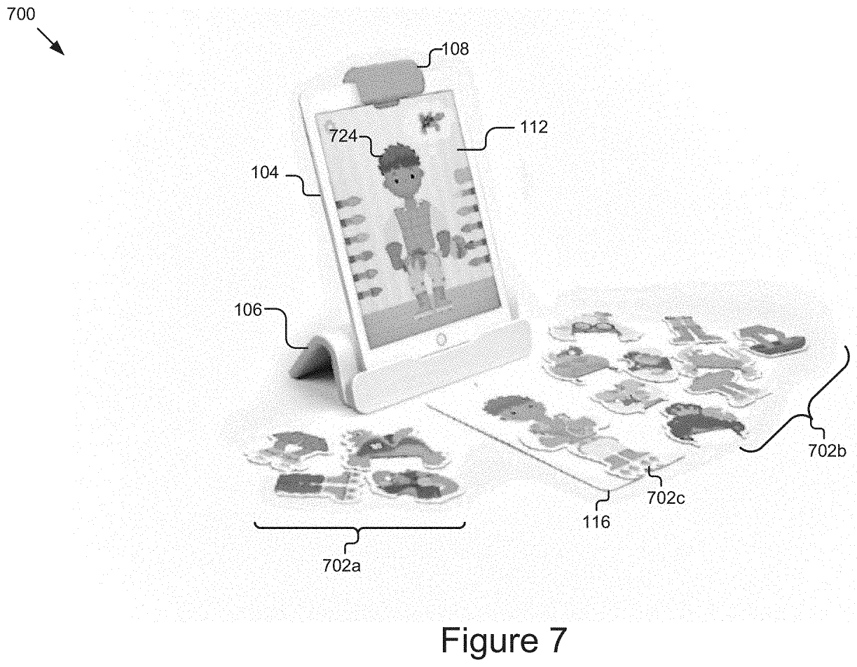

FIG. 7 is an example configuration 700 for using virtualizations of tangible object components. As shown in the example, the physical activity surface 116 in some implementations may smaller than a field-of-view of the camera 110. In this example, the physical activity surface 116 may be a small board divided into three different sections and a specialized tangible interface object 702c may be placed on the smaller physical activity surface 116. The three sections of the physical activity surface 116 may represent a head portion, a body portion, and/or a feet portion of the specialized tangible interface object 702c and the detector 304 may be configured to identify one or more specialized tangible interface object(s) 702 placed on those different sections. In the example, the specialized tangible interface object 702c represents a person that can be dressed up in a variety of mix-and-match costumes represented by specialized tangible interface objects 702a and 702b. The specialized tangible interface objects 702c may represent the various portions of the person, such as a hat object, a body object, and/or a feet object. The different objects may be placed over the specialized tangible interface object 702c representing the person in order to depict dressing that person up in different costumes.

The detector 304 may be configured to identify when a hat object, body object, and/or feet object representing the specialized tangible interface objects 702a and 702b are positioned over a portion of the person representing the specialized tangible interface object 702c and determine a virtual representation 724 of that object based on the configuration and/or relative combined position of each of the specialized tangible interface objects 702a-702c. In some implementations, the detector 304 may be able to determine when one specialized tangible interface object 702a is switched for another tangible interface object 702b and update the virtual representation 724 in the virtual scene 112. For example, a user may switch out a hat on the person's head for a wig and the virtual representation 724 may display the wig configuration.

In further implementations, once the virtual representation 724 has been displayed in the virtual scene 112, the user 130 can select different customizations and/or enhancements to change the color of style of the virtual representation 724. For example, the virtual representation 724 may be displayed wearing a black wig and green pants and a user 130 may select a blue paintbrush from a display on the virtual scene 112 in order to update the color of the wig to be blue. The user 130 may then further select a sparkles enchantment option to make the green pants shimmer. These enhancement options may be further performed using logic based on a presentation of different tangible interface object(s) 120. For example, different colored tokens may be placed adjacent to the different portions of the specialized tangible interface object 702c and the activity application(s) 214 may cause the identified colors of the tokens to be used as enhancements to the corresponding portions of the virtual representation 724. This allows users 130 to create and customize their own virtual representations 724 with specific color options and costumes. It further teaches children the actions for cause-and-effect as the virtual representations 724 are customized and displayed in real-time as the user 130 changes the configuration of the specialized tangible interface object(s) 702.

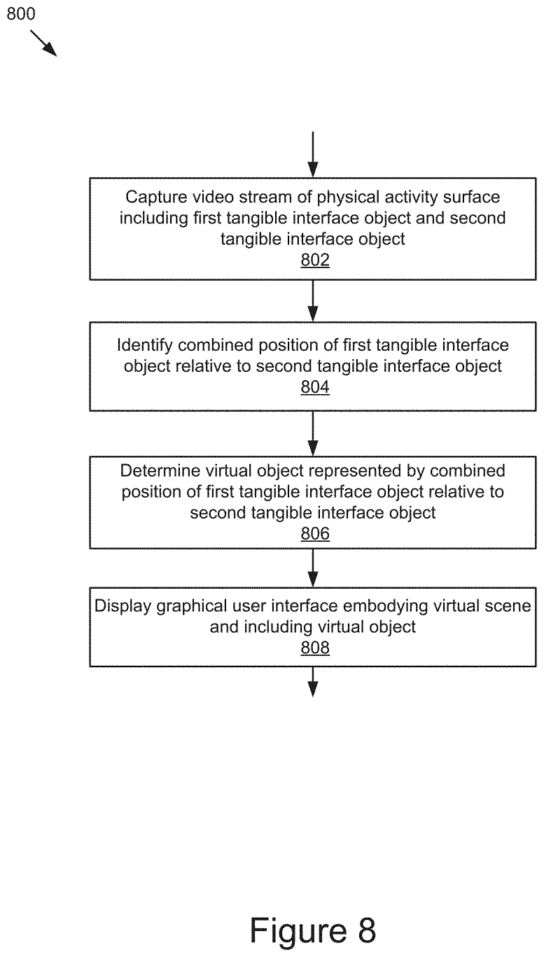

FIG. 8 is a flowchart of an example method 800 for virtualization of tangible object components. At 802, the video capture device 110 may capture a video stream of a physical activity surface 116 that includes a first tangible interface object 120 and a second tangible interface object 120. In some implementations, the first tangible interface object 120 and the second tangible interface object 120 may be one or more of a stick and/or a ring. In some implementations, the first and second tangible interface object(s) 120 may be positioned relative to each other by a user 130 in order to depict a physical object 132.

At 804, the detector 304 may identify a combined position of the first tangible interface object 120 relative to the second tangible interface object 120. The combined position may be the relative positions between the two tangible interface objects 120, such as if they are touching at the ends, resting at an end of one and a midpoint of the other, if they are placed on top of each other, how much calculated distance is between two points of the tangible interface objects 120, etc. The detector 304 may identify positions of orientations of each of the tangible interface objects 120 and how those positions and orientations relate to each of the other tangible interface objects 120.

At 806, the activity application(s) 214 may determine a virtual object 122 using the combined position of the first tangible interface object 120 relative to the second tangible interface object 120. In some implementations, the activity application(s) 214 may match the combined position of the tangible interface objects 120 to a database of virtual objects 122 that are formed out of various virtual components. The activity application(s) 214 may match the individual positions and orientations of each of the tangible interface objects 120 relative to each other to positions and orientations of the various virtual components forming the virtual objects 122 and identify one or more best matches. In some implementations, the activity application(s) 214 may create matching scores for how many points are similar between the combined position of the tangible interface objects 120 and the virtual objects 122. In further implementations, any virtual objects 122 that have a matching score that exceeds a matching threshold may be considered a candidate virtual object 122. In further implementations, if more than one virtual object 122 is considered to be a candidate, a second matching may be performed by the activity application(s) 214 that has a matching score with a higher threshold than the first matching. In some implementations, the matching algorithm and the database of virtual objects 122 may be updated using machine learning as additional virtual objects 122 and learning sets are added in the database. The machine learning may allow the activity application(s) 214 to identify additional matches over time based on the configuration and combined positions of various tangible interface object(s) 120.

At 808, the activity application(s) 214 may display a graphical user interface embodying a virtual scene 112 and including the virtual object 122. In some implementations, the virtual scene 112 may depict a routine and/or animation based on an identity of the virtual object 122 and this may cause the virtual scene 112 to execute the routine based on what a user had created using the tangible interface object(s) 120

This technology yields numerous advantages including, but not limited to, providing a low-cost alternative for developing a nearly limitless range of applications that blend both physical and digital mediums by reusing existing hardware (e.g., camera) and leveraging novel lightweight detection and recognition algorithms, having low implementation costs, being compatible with existing computing device hardware, operating in real-time to provide for a rich, real-time virtual experience, processing numerous (e.g., >15, >25, >35, etc.) tangible interface object(s) 120 and/or an interaction simultaneously without overwhelming the computing device, recognizing tangible interface object(s) 120 and/or an interaction (e.g., such as a wand 128 interacting with the physical activity scene 116) with substantially perfect recall and precision (e.g., 99% and 99.5%, respectively), being capable of adapting to lighting changes and wear and imperfections in tangible interface object(s) 120, providing a collaborative tangible experience between users in disparate locations, being intuitive to setup and use even for young users (e.g., 3+ years old), being natural and intuitive to use, and requiring few or no constraints on the types of tangible interface object(s) 120 that can be processed.

It should be understood that the above-described example activities are provided by way of illustration and not limitation and that numerous additional use cases are contemplated and encompassed by the present disclosure. In the above description, for purposes of explanation, numerous specific details are set forth in order to provide a thorough understanding of the present disclosure. However, it should be understood that the technology described herein may be practiced without these specific details. Further, various systems, devices, and structures are shown in block diagram form in order to avoid obscuring the description. For instance, various implementations are described as having particular hardware, software, and user interfaces. However, the present disclosure applies to any type of computing device that can receive data and commands, and to any peripheral devices providing services.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms including “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Various implementations described herein may relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The technology described herein can take the form of a hardware implementation, a software implementation, or implementations containing both hardware and software elements. For instance, the technology may be implemented in software, which includes but is not limited to firmware, resident software, microcode, etc. Furthermore, the technology can take the form of a computer program product accessible from a computer-usable or computer-readable medium providing program code for use by or in connection with a computer or any instruction execution system. For the purposes of this description, a computer-usable or computer readable medium can be any non-transitory storage apparatus that can contain, store, communicate, propagate, or transport the program for use by or in connection with the instruction execution system, apparatus, or device.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems, storage devices, remote printers, etc., through intervening private and/or public networks. Wireless (e.g., Wi-Fi™) transceivers, Ethernet adapters, and modems, are just a few examples of network adapters. The private and public networks may have any number of configurations and/or topologies. Data may be transmitted between these devices via the networks using a variety of different communication protocols including, for example, various Internet layer, transport layer, or application layer protocols. For example, data may be transmitted via the networks using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), voice over Internet protocol (VOIP), file transfer protocol (FTP), WebSocket (WS), wireless access protocol (WAP), various messaging protocols (SMS, MMS, XMS, IMAP, SMTP, POP, WebDAV, etc.), or other known protocols.

Finally, the structure, algorithms, and/or interfaces presented herein are not inherently related to any particular computer or other apparatus. Various general-purpose systems may be used with programs in accordance with the teachings herein, or it may prove convenient to construct more specialized apparatus to perform the required method blocks. The required structure for a variety of these systems will appear from the description above. In addition, the specification is not described with reference to any particular programming language. It will be appreciated that a variety of programming languages may be used to implement the teachings of the specification as described herein.

The foregoing description has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies and other aspects are not mandatory or significant, and the mechanisms that implement the specification or its features may have different names, divisions and/or formats.

Furthermore, the modules, routines, features, attributes, methodologies and other aspects of the disclosure can be implemented as software, hardware, firmware, or any combination of the foregoing. Also, wherever an element, an example of which is a module, of the specification is implemented as software, the element can be implemented as a standalone program, as part of a larger program, as a plurality of separate programs, as a statically or dynamically linked library, as a kernel loadable module, as a device driver, and/or in every and any other way known now or in the future. Additionally, the disclosure is in no way limited to implementation in any specific programming language, or for any specific operating system or environment. Accordingly, the disclosure is intended to be illustrative, but not limiting, of the scope of the subject matter set forth in the following claims.

1. A method comprising:
capturing, using a video capture device associated with a computing device, a video stream of a physical activity scene, the video stream including a first tangible interface object and a second tangible interface object positioned on the physical activity scene;
identifying, using a processor of the computing device, a combined position of the first tangible interface object relative to the second tangible interface object;
determining, using the processor of the computing device, a virtual object represented by the combined position of the first tangible interface object relative to the second tangible interface object; and
displaying, on a display of the computing device, a graphical user interface embodying a virtual scene, the virtual scene including the virtual object.

2. The method of claim 1, wherein the first tangible interface object is a stick and the second tangible interface object is a ring.

3. The method of claim 2, further comprising:
identifying, using the processor of the computing device, a first position and a first orientation of the stick;
identifying, using the processor of the computing device, a second position and a second orientation of the ring; and
wherein identifying the combined position includes matching the first position and the first orientation of the stick and the second position and the second orientation of the ring to a database of virtualizations that includes the virtual object and the virtual object is formed out of one or more of a virtual stick and a virtual ring.

4. The method of claim 3, wherein the virtual object represents one of a number, a letter, a shape, and an object.

5. The method of claim 1, wherein the virtual scene includes an animated character, the method further comprising:
displaying the animated character in the graphical user interface;
determining an animation routine based on the combined position of the first tangible interface object relative to the second tangible interface object; and
executing, in the graphical user interface, the animation routine.

6. The method of claim 1, wherein the video stream includes a third tangible interface object positioned in the physical activity scene, the method further comprising:
updating the combined position based on a location of the third tangible interface object relative to the first tangible interface object and the second tangible interface object;
identifying a new virtual object based on the updated combined position; and
displaying, on the display of the computing device, the virtual scene including the new virtual object.

7. The method of claim 1, further comprising:
displaying, on the display of the computing device, a virtual prompt, the virtual prompt representing an object for a user to create on the physical activity scene;
detecting in the video stream, a placement of the first tangible interface object and the second tangible interface object on the physical activity scene;
determining that the combined position of the first tangible interface object relative to the second tangible interface object matches an expected virtual object based on the virtual prompt; and
displaying, on the display of the computing device, a correct animation.

8. The method of claim 7, wherein the virtual prompt includes highlighting to signal a shape of the first tangible interface object.

9. The method of claim 8 further comprising:
determining, using the processor of the computing device, that the first tangible interface object is placed incorrectly to match the expected virtual object; and
determining, using the processor of the computing device, a correct placement of the first tangible interface object.

10. The method of claim 9, wherein the highlighting is presented on the display responsive to determining that the first tangible interface object is placed incorrectly and the highlighting signals the correct placement of the first tangible interface object.

11. A physical activity visualization system comprising:
a video capture device coupled for communication with a computing device, the video capture device being adapted to capture a video stream that includes a first tangible interface object and a second tangible interface object positioned on a physical activity scene;
a detector coupled to the computing device, the detector being adapted to identify within the video stream a combined position of the first tangible interface object relative to the second tangible interface object;
a processor of the computing device, the processor being adapted to determine a virtual object represented by the combined position of the first tangible interface object relative to the second tangible interface object; and
a display coupled to the computing device, the display being adapted to display a graphical user interface embodying a virtual scene, the virtual scene including the virtual object.

12. The physical activity scene visualization system of claim 11, wherein the first tangible interface object is a stick and the second tangible interface object is a ring.

13. The physical activity scene visualization system of claim 12, wherein the processor of the computing device is further configured to:
identify a first position and a first orientation of the stick;
identify a second position and a second orientation of the ring; and
wherein identifying the combined position includes matching the first position and the first orientation of the stick and the second position and the second orientation of the ring to a database of virtualizations that includes the virtual object and the virtual object is formed out of one or more of a virtual stick and a virtual ring.

14. The physical activity scene visualization system of claim 13, wherein the virtual object represents one of a number, a letter, a shape, and an object.

15. The physical activity scene visualization system of claim 11, wherein the virtual scene includes an animated character, and wherein the display is adapted to display the animated character in the graphical user interface, and wherein the processor is adapted to:
determine an animation routine based on the combined position of the first tangible interface object relative to the second tangible interface object; and
execute in the graphical user interface, the animation routine.

16. The physical activity scene visualization system of claim 11, wherein the video stream includes a third tangible interface object positioned in the physical activity scene, and wherein the processor is further adapted to:
update the combined position based on a location of the third tangible interface object relative to the first tangible interface object and the second tangible interface object;
identify a new virtual object based on the updated combined position; and
wherein the display is further adapted to display the virtual scene including the new virtual object.

17. The physical activity scene visualization system of claim 11, wherein the display is further adapted to display a virtual prompt, the virtual prompt representing an object for a user to create on the physical activity scene and wherein the processor is further adapted to:
detect in the video stream, a placement of the first tangible interface object and the second tangible interface object on the physical activity scene;
determine that the combined position of the first tangible interface object relative to the second tangible interface object matches an expected virtual object based on the virtual prompt; and
wherein the display is further adapted to display a correct animation.

18. The physical activity scene visualization system of claim 17, wherein the virtual prompt includes highlighting to signal a shape of the first tangible interface object.

19. The physical activity scene visualization system of claim 18 wherein the processor is further adapted to:
determine that the first tangible interface object is placed incorrectly to match the expected virtual object; and
determine a correct placement of the first tangible interface object.

20. The physical activity scene visualization system of claim 19, wherein the display is further adapted to present the highlighting on the display responsive to the processor determining that the first tangible interface object is placed incorrectly and the highlighting signals the correct placement of the first tangible interface object.

21. A method comprising:
capturing, using a video capture device associated with a computing device, a video stream of a physical activity scene, the video stream including a first tangible interface object representing a stick and a second tangible interface object representing a half-ring, the first tangible interface object being positioned adjacent to an end of the second tangible interface object on the physical activity scene to create a shape;
identifying, using a processor of the computing device, a first position of the first tangible interface object;
identifying, using the processor of the computing device, a second position of the second tangible interface object;
identifying, using the processor of the computing device, the shape depicted by the first position of the first tangible interface object relative to the second position of the second tangible interface object;
determining, using the processor of the computing device, a virtual object represented by the identified shape, by matching the shape to a database of virtual objects and identifying a matching candidate that exceeds a matching score threshold; and
displaying, on a display of the computing device, a graphical user interface embodying a virtual scene, the virtual scene including the virtual object.
